(19) United States
(12) Patent Application Publication
(10) Pub. No.: US 2017/0010852 A1
(43) Pub. Date: Jan. 12, 2017

(54) System and Method for Providing Audio Services to Gaming Applications

(71) Applicant: TIMOTHY DONALD AMANN, ODENTON, MD (US)

(72) Inventor: TIMOTHY DONALD AMANN, ODENTON, MD (US)

(21) Appl. No.: 14/793,725

(22) Filed: Jul. 7, 2015

(51) Int. Cl. G06F 3/16; G07F 17/32

(52) U.S. Cl. CPC G06F 3/165; G07F 17/3204; G07F 17/3237; G07F 17/3244

(57) ABSTRACT

A system and method for providing audio services to a gaming application. A developer typically provides, in addition to a Main Server and Song Server, a system for interfaces or other interactive connections to the server or servers, such as a Gaze Developer Interface, User Device and Artist Interface. Music or other audio input is streamed to a user's device from the Main Server or Song Server, selected by choice and/or an algorithm, and files of an artist are uploaded from the Artist Interface. Feedback data and various metrics of interest are transmitted from the Main Server back to the Game Developer Interface and Artist Interface, and data regarding the user and preferences is transmitted from the User Device to the Main Server. A number of interactions between the user and artist or music are supported.

CROSS REFERENCE TO RELATED APPLICATION(S) This application claims the benefit of U.S. Provisional Application No. 62/022,011 entitled “SYSTEM AND METHOD FOR PROVIDING AUDIO SERVICES TO GAMING APPLICATIONS,” filed on Jul. 8, 2014, the subject matter of which is hereby incorporated therein by reference in its entirety.

### TECHNICAL FIELD OF THE INVENTION

The present invention relates to the general art of applications and websites, and music therefor.

### BACKGROUND OF THE INVENTION

Both musical artists and game application developers face significant problems in accomplishing their goals. Most musicians have limited effective means of reaching potential listeners with their material and building fan bases. At the same time, while software applications, particularly gaming applications, have become popular as a whole, that very popularity has made it difficult for most developers to make money front their applications.

Current methods for independent artists to reach their potential market of fans are highly ineffective because they fail to get the music in front of the potential fans who may not know of the existence of the artist. Artists can be trapped in a dilemma of trying to acquire new fans without an effective way of putting their music before them. This can be particularly true for independent artists who do not have big label hacking. It can feel as if they need to have a fan base to receive such recording, label backing, but need recording label backing to reach and obtain a fan base. Needless to say, it is the fan base that typically provides the monetary base for an artist to succeed and reach even more fans.

Traditionally, artists have attempted to reach potential listeners with advertising, such as in magazines, billboards, radio ads, persuading radio stations to play their music and the like. These methods have been expensive and typically utilized by those who already have record label backing. Additionally, such blanket approaches are difficult to customize to reach the people most likely to become part of an artist's fan base. Recently, new technologies have evolved that have given independent artists more opportunities. However, the effectiveness of technological solutions like YouTube, Myspace, Facebook, Spotify and iTunes in reaching new fans is seriously limited because they are all generally accessed and controlled by user searches and links. They require a potential listener to purposely seek out new music they do not know of with intention, which rarely occurs. Further, if a potential listener is unaware of an artist, so has no reason to search fir that artist, the chances of such a potential listener finding that artist by chance are small. Often, word of an artist spreads by “word of mouth” but this depends on potential fans knowing someone who knows of the artist and mentions the artist, which is also highly subject to chance.

Further, all these methods suffer from a lack of interactivity between fans and artists, and opportunities to inform potential fans about upcoming shows, albums or other information that may be of interest. This has been partly addressed by artist websites, email lists, Youtube.com channels and the like. However all these depend on the potential listener knowing of the artist and going to the website, being placed on the email it and the like. Accordingly, these have the difficulties already mentioned in reaching potential fans and sufficiently expanding fan base. As a result, many artists who could have appealed to listeners and obtained fan bases may abandon their music because they do have an effective means of reaching these potential fans and achieving the success they desire. The artists fail to achieve their goals and potential fans lose out on music that they would have enjoyed.

Application developers, particularly gaming application developers, also face problems turning their passion and interests into financially sustaining concerns. Though a very small percentage of developers generate significant revenue on better-known mobile games, the vast majority of developers fail to realize meaningful revenue. For example, according to Gartner, a leading information technology research and advisory company, only 0.01% mobile applications will be considered financially successful by their owners through 2018.

Methods for developers to generate revenue are limited, and at least in the case of gaming, difficult to implement without losing all or most players. The options are primarily providing advertising during the gaming experience, requiring an up-front purchase of the application, or providing offers to make purchases within the application (the “freemium” model).

Taking these in turn, advertising generates extremely low revenue due to the low price per “click” or impression paid by advertisers on mobile devices. For instance, an application with 5,000 daily active users showing 4 ads per user per day would equal 20,000 impressions per day. This is an impressive number, yet assuming a typical $3.00 CPM (cost per mille/thousand impressions) and a 50% revenue sharing arrangement between the advertising network and the developer, this would only yield $30 a day for the developer.

While the up-front purchase model is successful for certain types of specialized applications, most developers have abandoned it for game applications. Because of the sheer volume of free games available of similar quality and content, users are generally unwilling to pay for games.

Providing offers to purchase within applications while the user is running the application (In-App Purchase) is currently the most effective method for generating revenue. However, only a small percentage of users actually make an In-app purchases. Usually, generating revenue requires a high quality, well marketed game that draws sufficient numbers of users. To achieve success at this level generally requires significant financial backing, typically from major game development studios and publishers. Independent and smaller game studios and publishers generally cannot compete.

In-app purchases also carry potential risk because the developer does not know who is making the purchases. For example, Apple agreed to pay $32.5 million in refunds to settle a recent class action lawsuit for unauthorized purchases made by children. Given all this, developers often expend considerable time and effort creating applications and games, only to find a small or non-existent financial payoff for their efforts

Therefore, there is a need in the art for an improved method that enables musical artists to obtain potential fans and markets for their music. There is further, a need for an improved method that can be tailored to target the specific types of people most likely to be fans of a given artist; and to access gaming audiences by a method for playing their music on gaming applications as background sound for games, such as mobile gaming, websites, console games, computer games and the like; and that provides for interactive activity between the artists and potential audience garners. There is, further, a need in the art for additional methods for providing revenue streams for ginning developers.

### SUMMARY

These and other objects are achieved by a system and method for providing audio services to a gaming application. The interactive system utilizing the method herein is comprised, generally, of a Developer Interface, a Main Server, a User Interface, an Artist Interface, and a Song Server

A system developer provides a Main Server, and a game developer downloads the application software from the Main Server, integrates the application software with the game software, in which it is then downloaded to the User Device. The system developer typically provides, in addition to the Main Server, a system of interfaces or other interactive connections to the Main Server necessary to the system, such as the Game Developer Interface, User Device and Artist Interface. The game developer then selects the type of music to be streamed to a user's device, and enters the selections at the Game Developer Interface.

The game developer can make decisions, through administrative privileges provided by the system developer, about how the software will be run, including, for example, the level of choice the user has concerning the music played on the User Device. The game developer can choose to pre-select the type of music for the user, or allow the music preferences of the user to override the game developer's music genre choices. The user can also be given a choice of whether to use the streamed application music herein, the default game music, no music, or if the-music, application software is run, whether the user can play preferred music. The game developer can also select which users are required to use music from the Song Server, to monetize the application and which can elect whether to do so. Data regarding the game developer selections is transmitted from the Game Developer Interface.

Feedback data and various entries of interests, primarily concerning application engagement are, in turn, transmitted from the Main Server back to the Game Developer Interface during operation of the system.

From the Artist Interface, the music files of an artist are uploaded to a Song Server. From the Song Server, musical selections are transmitted, or streamed, to the User Device while the User Device is in use. Simultaneously, the Main Server integrate relevant data such as game developer input from the Game Development Interface, user music preferences from the User Device, and data from the artist.

The Main Server applies a pre-written algorithm to the various data. The algorithm determines which songs will be streamed to each User's Device and in which order. This is transmitted from the Main Server to the Song Server, whereupon the Song Server streams the music accordingly to the User Device, as discussed.

As the game is played and the music plays, an unobtrusive tag or marker showing the name of the music application appears in a corner of the screen, so as to be accessible and visible to the user, while not interfering with the game itself. Essentially, the music software application functions like an application within the gaming application. During regular gameplay, the music streamed to User Device can be set, either by the user or game developer, to override regular background music of the game. Further, sound effects for any games continue to play in conjunction with the Streamed music.

If a user becomes interested in a particular song or artist, or simply wishes to peruse musical information, the user can simply click on the tag or marker. Doing so will pause the game and bring up a music application interface graphic. Information that has been selected as most suitable and helpful to the user and artist can be provided as well as links and other items of Interest. The interface Screen can have multiple purposes including, for example, promoting the artist and song, capturing user data anti music preferences, enabling user feedback, allowing for interaction between users and artists, and helping crowdfund artist campaigns. The initial screen will typically promote the artist and the song currently playing. The user can follow artist links to external websites outside the application to learn more about the artist and/or hear more of the artist's work.

The user can provide a song rating which is data that assists the algorithm in supplying the best choices of music to the user. If the option is provided by the game developer, users can also skip songs not of interest, which can be additional data used by the algorithm. A “Song History” of music played, and/or of preferred music, can be created. Whenever the user wants to access specific songs that have been played, the user can turn to this “Song History” to do so. Further, the artist can provide custom messages to users

As songs are streamed to the User Device, data regarding the user and preferences, such as user ratings, is transmitted from the User Device to the Main Server, and ether interactions between the user and artist or music are possible as well. A comments section can also be provided, wherein a user can also make comments about songs or artists, which are then uploaded via the Main Server to the appropriate Artist Interface. There can also be a messaging section that allows users and artists to message directly between the Artist Interface and the User Device, via the Main Server. If a user wishes to purchase a song or have other interaction with the music artist, such data is likewise uploaded to the Main Server and processed. The user can access any suitable external locations such websites or interfaces such as, for example, itunes.com or amazon.com, where they can browse and purchase music. In another embodiment, selected music of participating artists, as well as appropriate software for processing browsing and purchase, is loaded into the Main Server. The artist will input relevant data regarding the artist at the Artist interface, and such data will be transmitted to the Main Server.

The Main Server transmits appropriate metrics and data to the Artist Interface, where a real-time dashboard can be provided. Information available to the artist could include, for example, the number of times the artist's songs) have been streamed, how much the artist paid, on average, per song, streamed, a listing of each song rating by user and applicable rating statistics such as average, median, and percentage of users at each rating level; messages received from users, where songs were played, and any other relevant data of interest that has been obtained.

### BRIEF DESCRIPTION OF THE DRAWINGS

FIG. 1 is a schematic diagram of the process of the invention

FIG. 2 is a schematic diagram of an alternate embodiment of the invention.

FIG. 3 is a sample view of a user screen using the method herein

FIG. 4 is the sample view of FIG. 3 showing selected features of the invention herein.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference number refer to like features throughout this description.

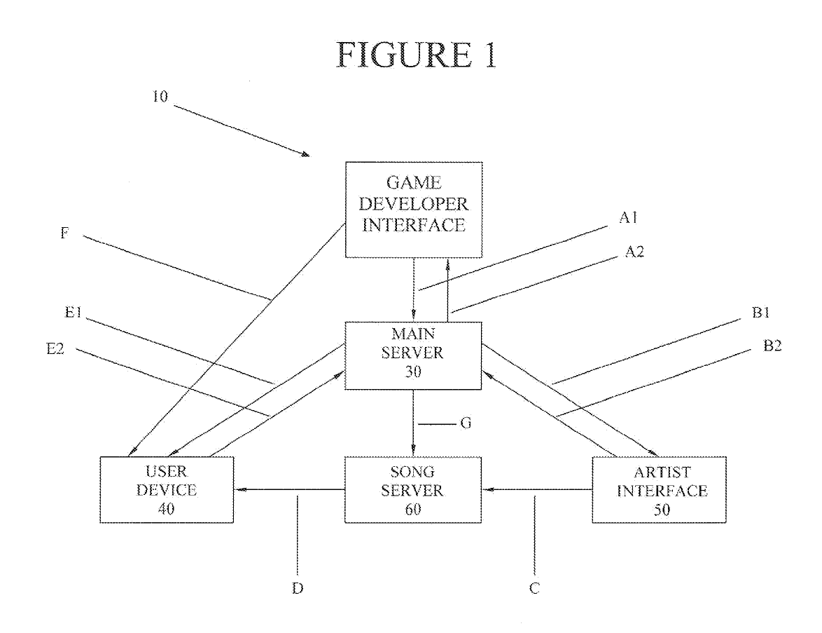

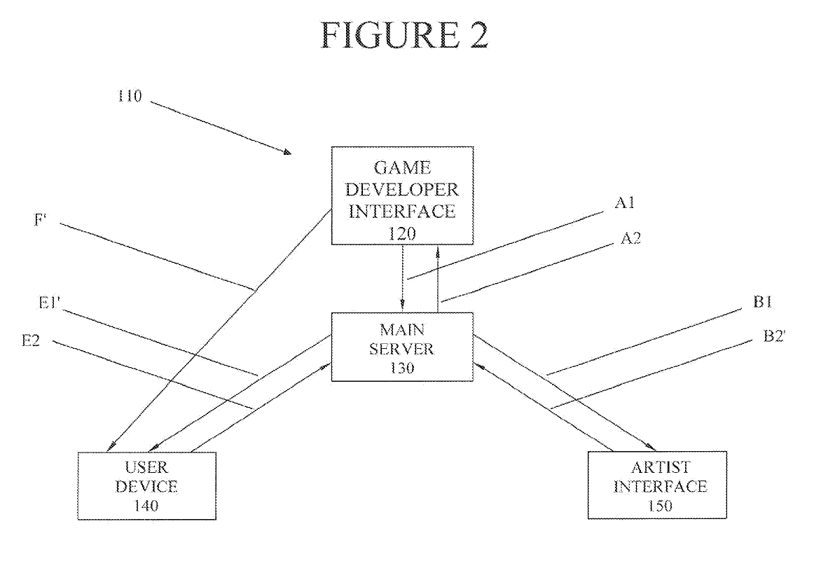

One exemplary embodiment of the present invention is shown in FIGS. 1-2. Turning to FIG. 1, a first embodiment of a method for providing background music to gaming users that can be used by musical artists to reach more potential fans, while providing an additional service to game developer users, is shown.

The interactive system 10 utilizing the method herein is comprised, generally, of a Developer Interface 20, a Main Server 30, a User Interface 40, an Artist Interface 50, and a Song Server 60.

For purposes of this application, it is to be understood that the following tennis are defined as follows: The term “Game Developer” is defined as a party or entity providing an application, gaming or non-gaming, mobile or non-mobile, and/or through a website to at least one user. The term “user” is defined as a party or parties who use a provided gaming application, whether there is supplied background music or not. The term “System Developer” is defined as a party or entity providing the music application software—software that integrates with the application software supplied by the Game Developer—and system of implementation as described herein. However, the game developer can additionally assume the role of system developer, or vice versa, so that both roles are conducted by the same party. The term “music provider” or “artist” is defined as a party or entity providing audio content that accompanies any gaming application using the system and method herein. Audio content in this embodiment is centered upon music, but can be any type of audio content that can be streamed or downloaded including, but not limited to, podcasts, radio or television shows, comedy or other types of audio transmission and content.

Further, any interface discussed herein such as, for example, the Game Developer Interface 20 or Artist Interface 50 is to be defined as any technology and/or device that allows interaction with other servers, devices and/or technologies as discussed herein. These can include, for a few examples, a laptop or PC computer, mobile, ipad, tablet, google glass, virtual reality devices or any suitable technology; though it is to be understood that these examples are representative only and not limiting.

Turning to FIG. 1, a system developer provides a Main Server 30, and a game developer downloads the application software from the Main Server 30 to the User Device 40, a process driven and controlled via the Game Developer Interface 20, as indicated by Arrow F. After the application software has been downloaded to the User Device 40, it can be updated at any later time as necessary. The system developer typically provides, in addition to the Main Server 30, a system for interfaces or other interactive connections to the Main Server 40 necessary to the system, such as the Game Developer Interface 20, User Device 40 and Artist Interface 50.

The game developer then selects the type of music to be streamed to a user's device and enters the selections at the Game Developer Interface 20. The Game Developer interface 20 can be any comprised of any suitable technology and device or devices in the art capable of uploading and downloading the appropriate data as discussed herein. In this embodiment, the Game Developer Interface 20 is comprised of a website run by a server.

The game developer can make decisions, through administrative privileges provided by the system developer, about how the software will be run, including, for example, the level of choice the user has concerning the music played on the User Device 40. The game developer typically makes musical selections at the Developer Interface 20 and further determines and implements any other necessary music and account settings, though these functions may be performed by the system developer. The game developer can choose to pre-select the type of music for the user, or allow the music preferences of the user to override the game developer's music genre choices. The user can also be given a choice of whether to use the streamed application music herein, the default game music, or no music, or preferred music. The game developer typically would make these choices when the application software is integrated with the Main Server 30. The data regarding the game developer selections is transmitted from the Game Developer interface 20 to the Main Server 30, as indicated by Arrow A1. The game developer may select the type of music to be streamed to a user's device, by matching the type of music to the type of game. As example, a game developer might choose harder type music, such as metal or rap with a harder beat, for a combat game, whereas fast-tempo music might be emphasized in a racing type game.

The game developer can also select which users are required to use music from the Song Server 60, to monetize the application and which can elect whether to do so. This can be done by any convenient and workable means in the art such as, in this embodiment, through entry and use of an administrative panel at the Game Developer Interface Website 20. The game developer, for example could require certain users to use the music application software based on game developer criteria, such as a user who has not made an in-app purchase in their first two weeks of gameplay. This could allow the game developer allow a way to monetize a previously unmonetized user.

The music application software, Main Server 30 and the game application software are integrated at an appropriate time before the application software is downloaded to the User Device 40. This is typically performed by the game developer though it may be done, when appropriate, by the system developer. In other words, the Main Server is set up to process and use the application software to be downloaded to the User Device 40.

Feedback data and various metrics of interests, primarily concerning application engagement are, in turn, transmitted from the Main Server 30 back to the Game Developer Interface 20 during operation of the system 10 as indicated by Arrow A2. This data can be stored, tracked processed, or have any other appropriate operations performed upon it at the Main Server 30.

The Main Server 30, like the Game Developer interface 20 can be any comprised of any suitable technology and device or devices in the art capable of uploading and downloading the appropriate data as discussed herein. In this embodiment, the Main Server 30 is comprised a server, or computer that interacts with all the other interfaces and devices of the system 10.

The system can be set so that the user can choose a specific type of music. Additionally, it can be set so that after any specific song has been streamed to and played at the User Device 40, and said song is in the user's stored history, stored in the Main Server 30 and viewable at Song History 260 on the User Device 40, the user can choose to access that song from the Song History 260 and play it a limited number of times. After the limited number of times, the user may be presented with an option to purchase the song from a music download website or other suitable source.

From the Artist Interface 50, the music files of an artist are uploaded to the Song Server 60 as indicated by Arrow C. The Song Server is typically also provided by the system developer, as well as programming that allows the Song Server 60 to interact with other appropriate servers, interfaces and/or devices, such as the Artist Interface 50, Main Server 30 and User Device 40. An artist interface 50 can be comprised of any suitable technology or device or devices appropriate for uploading music and uploading and downloading data and interacting, as discussed herein, and can include a website with server, mobile or non-mobile device, or any combination thereof.

While any workable financial arrangement is possible, in this embodiment, an artist pays either the game developer or system developer a small fee to provide their songs to users. The fees are, in turn, shared between the game developer and system developer. By this arrangement, is the system developer is compensated, the game developer obtains an additional revenue stream from something that would normally be an outgoing cost, and the musical artists pays little for access to more potential audience that can be specifically targeted. If the system developer and the game developer are the same party, all revenues would typically be realized by this single party.

From the Song Server, 60 musical selections are transmitted, or streamed, to the User Device 40 while the User Device is in use, as indicated by Arrow D. The song server 60 can be any technology and device in the art suitable for accepting and streaming music and accepting, integrating and transmitting data as discussed herein and in this embodiment, is comprised of at least one server. The User Device 40 can be any device and accompanying technology suitable for downloading and playing gaining applications, such as smart phones, other mobile gaming devices, laptops, tablets, PC's and others as known in the art. In this embodiment, the User Device 40 is a mobile gaming device.

Simultaneously, the Main Server 30 integrates relevant data such as game developer input from the Game Development Interface 20, user music preferences from the User Device 40, data from the artist such as artist campaign data, data the music artist would like to transmit to the user, artist budgets and max CPP (Cost Per Play), and the type of game being played by the user.

The Main Server 30 applies a pre-written algorithm to the various data. The algorithm to determines which songs will be streamed to each User's Device 40 and in which order. This is transmitted from the Main Server 30 to the Song Server 60, as indicated by Arrow G, whereupon the Song Server 60 streams the music accordingly to the User Device 40, as discussed.

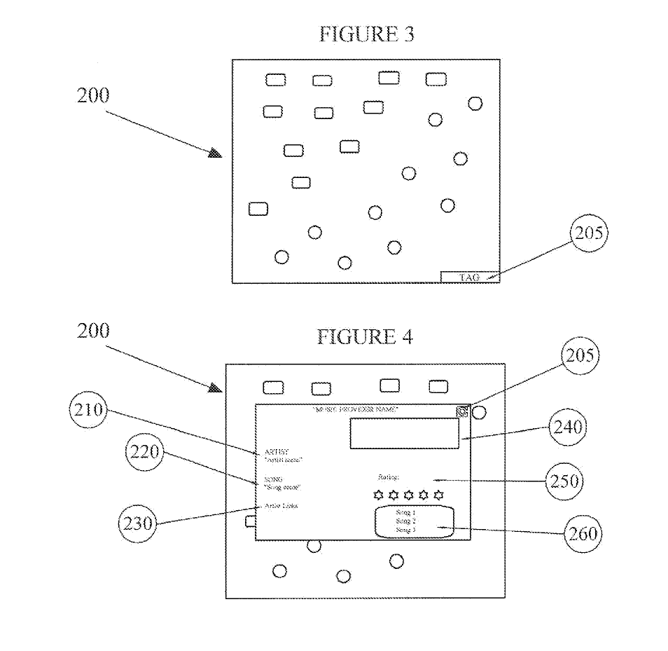

Turning briefly to FIG. 3, a typical gaining screen 200 on a User Device 40 is shown. As the game is played and the music plays, an unobtrusive tag or marker 205 showing the name of the music application appears in a corner of the screen, so as to be accessible and visible to the user, while not interfering with the game itself. In one embodiment, the tag or marker 205 is in the form of a small rectangular box that attached to the edge of the screen 200. The specific placement of the box and the existence of the box in general can be determined by the game developer. The box can have static text or scrolling text revolving between, for example, the name of the music application, the artist/band name, and the name of the song currently being played.

Essentially, the music software application functions like an application within the gaming application. During regular gameplay, the music streamed to User Device 40 can be set, either by the user or game developer, to override regular background music of the game. Further, sound effects for any games continue to May in conjunction with the Streamed music.

Turning to FIG. 4, if a user becomes interested in a particular song or artist, or simply wishes to peruse musical information, the user can simply click on the tag or marker 205. In other embodiments, the tag or marker 205 can be in in the form of whatever interface the game developer deems appropriate. In other embodiments, a user can initiate the interface, rather than via a tag or marker 205, within a pause menu, hotkey, voice command or any other means known in the art, as appropriate. Doing so will pause the game and bring up a music application interface graphic. Information that has been selected as most suitable and helpful to the user and artist can be provided as well as links and other items of interest.

The Interface Screen 205 can have multiple purposes including, for example, promoting the artist and song, capturing user data and music preferences, enabling user feedback, allowing for interaction between users and artists, and helping crowdfund artist campaigns.

In this embodiment, the initial screen will promote the artist and the song currently playing. The user can learn artist information 210 as well as song information 220. This page will contain the band's name, the song's name and various links as determined by the artist. The user can follow artist links to external websites outside the application to learn more about the artist and/or hear more of the artist's work. Typical links may be the artist's website, Facebook.com page, YouTube.com page, or iTunes.com, but can be any appropriate chosen useful locations.

The user can provide a song rating 240, on a 1-5 star scale in this embodiment, which is data that assists the algorithm in supplying the best choices of music to the user. If the option is provided by the game developer, users can also skip songs not of interest. A “Song History” of music played, and/or of preferred music, can be created. Whenever the user wants to access specific songs that have been played, the user can turn to this “Song History” to do so.

Further, the artist can provide custom messages to users 250. These messages can be customized to date and if the User Device 40 has GPS information or a traceable web address (H address), based upon user location. For example, an artist could customize tour date information to users near each tour stop location just before the tour stop.

Returning to FIG. 1, as songs are streamed to the User Device 40, data regarding the user and preferences, such as user ratings, is transmitted from the User Device to the Main Server 30, as indicated by Arrow E2.

Other interactions between the user and artist or music are possible as well. As a few further examples, on another screen (not shown), the user can set music preferences to specific types of lisle genres, such as, for example, hip-hop or Rock. This, along with data collected regarding songs that the user skips and user rating data can be uploaded to the Main Server 30 and taken into account by the algorithm to tailor music selections to a specific user.

A comments section can also be provided, wherein a user can also make comments about songs or artists, which are then uploaded via the Main Server 30 to the appropriate Artist Interface 50. Artists can, through the Artist Interface 50, remove comments as necessary as well as require approval before posting. There can also be a messaging section that allows users and artists to message directly between the Artist Interface 50 and the User Device 40, via the Main Server 30. Further, a user could view data, for example a chronological view, regarding the history of songs streamed to the User Device 40 and played and ratings for each song, and even, if this level of choice has been given the user by the game developer, replay songs of interest as part of the music stream and filter songs by various criteria, such as most played or by genre.

If a user wishes to purchase a song or have other interaction with the music artist, as will be discussed, such data is likewise uploaded to the Main Server 30 and processed. Such data may be sent from the Main Server 30 to the Artist Interface. The user can access any suitable external locations such websites or interfaces such as, for example, itunes.com or amazon.com, where they can browse and purchase music.

In another embodiment, selected music of participating artists, as well as appropriate software for processing browsing and purchase, is loaded into the Main Server 30. If the user becomes interested in an artist's music, the user would have the option of going to the Main Server 30, rather than an external site. Here, the user can browse music and purchase specific la songs or albums by participating artists. In other words, a function of the Main Server 30 would be to act as an online store and point of purchase for music. This would result in greater convenience for a user in accessing music of interest and increased opportunity for artists to directly reach listeners.

Data of interest outside of the music stream is delivered to the User Device 40 from the Main Server 30, as indicated by Arrow E1. Such data may include the history of previous songs streamed, the user's ratings, comments regarding songs or artists from other users, the user's current preferences set, and other relevant data.

The artist will input relevant data regarding the artist at the Artist interface 50, and such data will be transmitted to the Main Server 30, as indicated by Arrow B2. The artist can, in turn, forward chosen data, such as for example, the band and album names, song names and artist messages, to the User Device 40. Such data could include, for example, campaign criteria, band and artist data, credit card information for payment, registration information, the monthly budget of the artist and other relevant data. This data is sent to the Main Server 30.

As indicated by Arrow B1. The Main Server 30 transmits appropriate metrics and data to the Artist Interface 50, such as, for example, the number of users who listened to the sung, messages received from users, ratings received, cost per song streamed, where songs were played, and any other relevant data of interest that has been obtained.

Artists can also create campaigns based on demographic, geographic, and other known criteria of users in order to more effectively target their potential listenership, thereby receiving increased value. Depending upon known data about users, an artist could set target groups for their songs according to age, gender, genre preferences, the specific games being played, the type of User Device 40, the location of the user, dates or time of day, users who rate the artist or similar artists highly, users who choose the music application at least a given percentage of the time, and other suitable criteria. Further, the artist can make a selection to have the algorithm remove listeners who, over time and decisions, prove to be uninterested, thereby reducing wasted song plays and increasing value for the artist.

Artists receive further value from the system in that they can create a specific campaign for each song. A campaign creation page can be provided at, and managed through, the artist interface 50]]. This can appear to the artist as a provided campaign web page similar to other advertising campaign pages at well-known sites such as Google, Yahoo, Facebook and other operating advertising networks. Within the campaign screen, the artist can, through the Artist Interface 50, upload songs, input campaign data, provide links for users, add custom messages for users such as upcoming shows and dates, and set multiple criteria.

Finally, an artist can determine the daily budget or lifetime budget of the campaign and maximum the artist is willing to pay each time their song is played. Additionally, artists can provide input at the Artist Interface 50 to set up crowdfunding (supporting projects by raising small amounts of money from large numbers of people) from friends, family and fans to fund campaigns. Crowdfunding may be accessible to the user via Song Information 220 or any other suitable game screen, as pre-determined. Crowdfunding would allow the user to make payments, via an established payment method like PayPal or Google Wallet, which would directly fund the campaigns of the artist.

At the Artist Interface 50, a real-time dashboard can be provided using data and metrics transmitted from the Main Server 30 as indicated by Arrow B1. Information available to the artist could include, for example, the number of times the artist's song(s) have been streamed, how much the artist paid, on average, per song streamed, a listing of each song rating by user and applicable rating statistics such as average, median, and percentage of users at each rating level. The artist can have the ability to filter ratings by user demographics and music preferences in order to gain insights into what users respond positively to their music. The number of users accessing the artist-provided website and a list of comments can also be indicated.

The system and method provide benefits to the game developer as well. One important benefit provided is providing a way to significantly increase the revenue of the game developer. However, rather than provide revenue by a method that decreases the gaming experience, such as in-application advertising, the method herein adds a variety of music, thereby enhancing the gaming application experience for the user.

This could allow game developers to provide multiple, perhaps millions or billions, of hours of content to users. However, unlike previous schemes fir providing music or sounds, the method herein also provides for monetization. Additionally, if the game developer chooses to rely solely on the streamed music, the game developer can save production costs and/or royalty costs for background music in that they could make money from it rather than paying for it

The method further provides, for the music artist, millions or even billions of hours of potential “airplay” for their music via a previously inaccessible channel. More value can be provided, as Main Server 30 can be set to ‘ping’ the User Device 40 at regular intervals, such as, in this embodiment, every ten seconds to confirm that the user is still playing the music, and the artist may only be charged for the play of sufficient length. The Main Server 30 can also capture data, if available on the User Device 40 regarding the music volume output on the User Device 40 to confirm that the music can actually be heard by the user. Adjustments to charging to the campaign, if appropriate, can be made. For example, if the combination of the User Device 40 volume and the application software volume settings insufficiently low, the song may stop streaming and/or the artist may not be charged for the duration of the low volume. If the volume level at the User Device 40 cannot be determined, the artist may not be charged or may be charged at a lower rate, as deemed appropriate.

A further advantage of this system and method of monetization over previous advertising and advertising-like schemes is that the user, rather than passively receiving advertising, is encouraged to interact and provides feedback to the system. This user-provided data increases the value to the artist and the user.

Further, music, unlike advertising, music is a saleable product in its own right, passive and usually welcome. The user can use the Gaming Device 40 without interacting with the music unless the user actively chooses to do so. Music adds value, to the game experience by offering variety and specific genres of music based on user preferences.

In FIG. 1, the Main Server 30 and the Song Server 60 are divided into two distinct components. Turning FIG. 2, and an alternative embodiment of the method and system 110, the Main Server 30 and the Song Server 60 of FIG. 1 are consolidated such that the Main Server 30′, a single server in this embodiment, performs the functions of both the Main Server 30 and the Song Server 60.

Arrow B2′ includes the music stream from the Artist Interface, which now goes to the Main Server 30′ where the algorithm interacts directly rather than being transmitted. Arrow E1′ now continues transmission of the music stream from the Main Server 30′. The other components and arrows are as in FIG. 1.

It is to be understood that these figures are meant to show the general system interaction and method, but are somewhat representational for clarity. A single User Device 40 is shown, but the number of actual user devices could be thousands or even millions. Similarly, a single artist interface 50 is shown. However, as each artist would likely have an individual interface or close thereto, the Main Server 30 and Song Server 60 or Main Server 30′ would, in real operation, likely interact with multiple, and perhaps even thousands of Artist Interfaces. Further, due to variables such as bandwidth, processing needs, location of users, and number of connections needed, there could be multiple, or even hundreds or thousands of integrated servers required to complete the tasks of the Game Developer Interface 20, Main Server 30, Song Server 60, and/or Main Server 30′ and complete the method herein.

By this system and method, musical artists can access gaming audiences by having their songs played on mobile and non-mobile gain rig applications such as for mobile gaming, websites, console games, computer games and the like, as part of the background of the gaining applications and interactively reach potential fans and customers, while providing a revenue stream to game developers to increase their success.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A method for providing background music or other audio content to application users comprising the steps of:
providing an interactive system comprised of a developer interface, at least one server, at least one artist interface, and at least one user device,
wherein the developer interface, main server and at least one artist interface are each comprised of a device, devices, or technology capable of uploading and downloading data,
providing a game developer,
providing one or more of a mobile or non-mobile gaining application or non-gaming application to the at least one user device by downloading application software either from the developer interface, the main server, or both, to the at least one user device,
wherein the at least one user device comprises a device or technology capable of
downloading and playing gaming applications and playing the music or other audio content,
streaming the music or other audio content to the at least one a user device,
transmitting data, metrics or both from the at least one user device to the main server, or both the main server and developer interface,
transmitting data from the developer interface to the main server,
transmitting data from the at least one artist interface to the main server, and
integrating the data transmitted from the developer interface, the at least one user device, and the at least one artist interface to the main server.

2. A method according to claim 1, further comprising the steps of:
providing a song server comprised of a technology, device, or devices capable of accepting, storing and provides music to stream or other audio content to stream, and uploading music files or other audio content from the at least one artist interface to the song server.

3. A method according to claim 2, further comprising the steps of:
streaming the music or other audio content from either the song server to the at least one user device, or
streaming the music or other audio content from the main server to the at least one user device.

4. A method according to claim 2, further comprising the steps of:
applying an algorithm to data at the main server capable of determining the music or other audio content to be streamed to the at least one user device and the order in which it is streamed, and
transmitting or streaming this order from the main server to the song server streaming the music or other audio content from the song server to the at least one user deuce in the order determined in the algorithm.

5. A method according to claim 2, comprising the further step of:
transmitting audio data from either the at least one artist interface or main server to the at least one user device.

6. A method according to claim 1, wherein the audio content is music and further comprising the step of either:
pre-selecting the genre of music to be streamed to the at least one user device, or
allowing at least one user of the at least one user device to select the music.

7. A method according to claim, 1, further comprising the steps of:
storing music or other audio content within the at least one user device,
providing a user history of music or other audio content played, and
selecting a song or other audio content from the provided user history.

8. Method according to claim 1, further comprising steps of:
storing music or other audio content within the at least one user device,
providing a user history of music or other audio content played,
selecting a song or other audio content from the provided user history,
providing ratings of the music or other audio content, and
providing written feedback back to the artist.

9. A method according to claim 1, wherein the at least one user device is a smart phone, other mobile gaming device, laptop, tablet, or PC.

10. A method according to claim 1, further comprising the steps of:
providing a tag or artier in a corner of the screen of the at least one user device,
providing data to the at least one user, on the tag or marker, about the music or other audio content, or both, being streamed to the at least one device.

11. A method according to claim 1, comprising, the further step of:
providing a user history to the at least care user device, and
selecting and accessing music or other audio content through the user history.

12. A method according to claim 1, further comprising the step of
selecting data and transmitting data from the at least one artist interface, through the main server, to the at least one user device.

13. A method according to claim 1, further comprising the step of:
transmitting metrics, data, or both from the main server to the at least one artist interface,
wherein the data is the number of users who listened to a song, messages received from users, ratings received by users, cost per song streamed, where songs were played, or other data regarding song usage.

14. A method according to claim 1, further comprising the steps of:
providing a system developer and
the system developer providing the music application software through the developer interface.

15. A method according to claim 1, wherein the developer interface, user interface, and artist interface are each capable of interacting with a laptop or PC computer, mobile phone, tablet, virtual reality device, or other computer-containing device.

16. A method according to claim 1, comprising wherein the artist interface is capable of accepting and processing monetary payment data and further comprising the steps of:
entering the payment data at the at least one user device, and
transmitting the payment data to the main server and processing the payment data using at least one algorithm.

17. A method according to claim 1, comprising the further steps of:
providing payment data,
transmitting data from the artist interface, at least one user device, or both, and
using an algorithm to select the music or other audio content to be transmitted or streamed to the at least one user device based on the payment data.

18. A method according to claim 1, comprising the further step of:
creating at least one campaign for at least one piece of music or other audio content, and collecting campaign data which is comprised of at least one of:
the file type or music genre of the music or other audio content, campaign budget,
a maximum number of plays or bid per piece of music or other audio content, or a user's geographical location.

19. A method according to claim 1, comprising the further steps of:
providing an algorithm and
using the algorithm to determines what music or other audio content is streamed or transmitted and to determines the monetary amount to charge an artist for a given piece of music or other audio content.

20. A method according to claim 1, comprising the further steps of:
providing and using an algorithm, wherein the algorithm utilizes
at least one of the file type of music or other audio content, genre of the music or other audio content, the budget of an artist, a maximum bid per song or number of songs, a target application or set of applications, or a user's geographical location,
to determine which music or other audio content to given user device.
